(19) United States
(12) Patent Application Publication
(10) Pub. No.: US 2011/0238304 A1
(43) Pub. Date: Sep. 29, 2011

(54) Method of Transmitting a Traffic Event Report for a Personal Navigation Device

(76) Inventor: Mark Steven Kendall, Auckland (NZ)

(21) Appl. No.: 12/731,144

(22) Filed: Mar. 25, 2010

(51) Int. Cl. G01C 21/26; G08G 1/00

(52) U.S. Cl. 701/208

(57) ABSTRACT

In a method of transmitting a traffic event report for a traffic event from a personal navigation device, positioning circuits determine position of the personal navigation device. Processing circuits calculate speed of the personal navigation device according to the position, determine a street the personal navigation device is traveling on according to the position, calculate difference of a speed limit of the street and the speed of the personal navigation device, and display a traffic event report dialog in the display upon detection of the difference being greater than a predetermined threshold. An input interface receives traffic event data through user input, and the networking circuits send the traffic event report including the traffic event data to the server.

### BACKGROUND OF THE INVENTION

1. Field of the Invention

The present invention relates to personal navigation devices, and more particularly, to a method of transmitting a traffic event report that utilizes and may be employed in a personal navigation device.

2. Description of the Prior Art

Global navigation satellite systems (GNSS) are satellite networks whose member satellites broadcast positioning signals that can be received anywhere on the globe. One such GNSS system is a NAVSTAR Global Positioning System (GPS) developed by the United States Department of Defense. The GPS system includes at least 24 Medium Earth Orbit satellites that broadcast signals with position and time information. A personal navigation device can received the signals, and utilize the signals to calculate position, local time, heading, and speed.

Personal navigation devices are becoming increasingly popular, and are found in many forms, e.g. automobile navigation devices, handheld navigation devices, navigation-enabled personal digital assistants (PDAs), and navigation-enabled smartphones. The personal navigation device is often utilized as a navigation tool for drivers, who either own a dedicated navigation device permanently mounted in their automobile, or a portable navigation device that may be mounted temporarily to their automobile through means such as a suction cup. When the personal navigation device is further equipped with mapping software, the position determined from the satellite signals may be mapped to a street address in the mapping software, and the heading determined from the satellite signals may be utilized to determine which direction the personal navigation device is traveling along the street. Utilizing the mapping software, the personal navigation device may then be used to determine a quickest or shortest route to a destination, and the route may be displayed in the personal navigation device, along with directions that guide the driver through various maneuvers along the route to the destination.

More recently, as the personal navigation devices have become more sophisticated, and have integrated more advanced electronics, the personal navigation devices are now equipped with means for establishing network connections, either with the Internet, or with dedicated navigation service networks. One example of the means for establishing the network connection is a General Packet Radio Service (GPRS) modem on a cellular phone that may be accessed by the personal navigation device through a Bluetooth transceiver paired with the cellular phone.

As the personal navigation device is connected through the network connection to external information databases and applications, new types of services have been developed that exploit the positioning and routing capabilities of the personal navigation device itself, as well as input to the personal navigation device by the driver. The data may be uploaded by the personal navigation device for use by other drivers with personal navigation devices that are able to connect to an application or database that utilizes the data.

One type of data that drivers may have difficulty obtaining through the personal navigation device is information on traffic incidents and traffic conditions along the driver's future route.

### SUMMARY OF THE INVENTION

According to a first embodiment of the present invention, a traffic event report for a traffic event is transmitted from a personal navigation device comprising processing circuits, positioning circuits, memory circuits, an input interface, a display, and networking circuits. The method of transmitting the traffic event comprises the positioning circuits determining position of the personal navigation device, calculating speed of the personal navigation device according to the position, determining a street the personal navigation device is traveling on according to the position, calculating difference of a speed limit of the street and the speed of the personal navigation device, and displaying a traffic event report dialog in the display upon detection of the difference being greater than a predetermined threshold. The input interface receives traffic event data through user input, and the networking circuits send the traffic event report comprising the traffic event data to the server.

According to an embodiment of the present invention, a personal navigation device for transmitting a traffic event report to a server comprises a display, positioning circuits, networking circuits, an input interface, and processing circuits. The positioning circuits are configured for determining position of the personal navigation device. The networking circuits are configured for establishing a network connection with the server for transmitting the traffic event report to the server. The input interface is configured for receiving traffic event data through user input. The processing circuits are configured for calculating speed of the personal navigation device according to the position, determining a street the personal navigation device is traveling on according to the position, calculating difference of a speed limit of the street and the speed of the personal navigation device, displaying a traffic event report dialog in the display upon detection of the difference being greater than a predetermined threshold, and controlling the networking circuits to transmit the traffic event report comprising the traffic event data to the server.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a personal navigation device according to an embodiment of the present invention.

FIG. 2 is a flowchart of a process for a personal navigation device transmitting a traffic event report corresponding to the traffic event to the server according to a first embodiment of the present invention.

FIG. 3 is a flowchart of a process for a server transmitting a traffic event report corresponding to a traffic event to a personal navigation device according to an embodiment of the present invention.

### DETAILED DESCRIPTION

To alert drivers who have access to a personal navigation device when a traffic condition arises near the driver's current position or along the driver's intended route, processes for transmitting traffic events to the personal navigation device based on notifications generated by other drivers or other personal navigation devices are provided. The notifications may be collected by a server, which may utilize the notifications to determine whether a traffic event is occurring. Examples of traffic events include an accident, heavy traffic, a road closure, road construction, etc. The server may transmit information about the traffic event to the personal navigation device, which may display or otherwise utilize the information for the benefit of the driver. The server may comprise at least processing circuits for processing data, memory for storing data, and networking circuits for receiving and transmitting data from and to networked devices through a data network, such as the Internet.

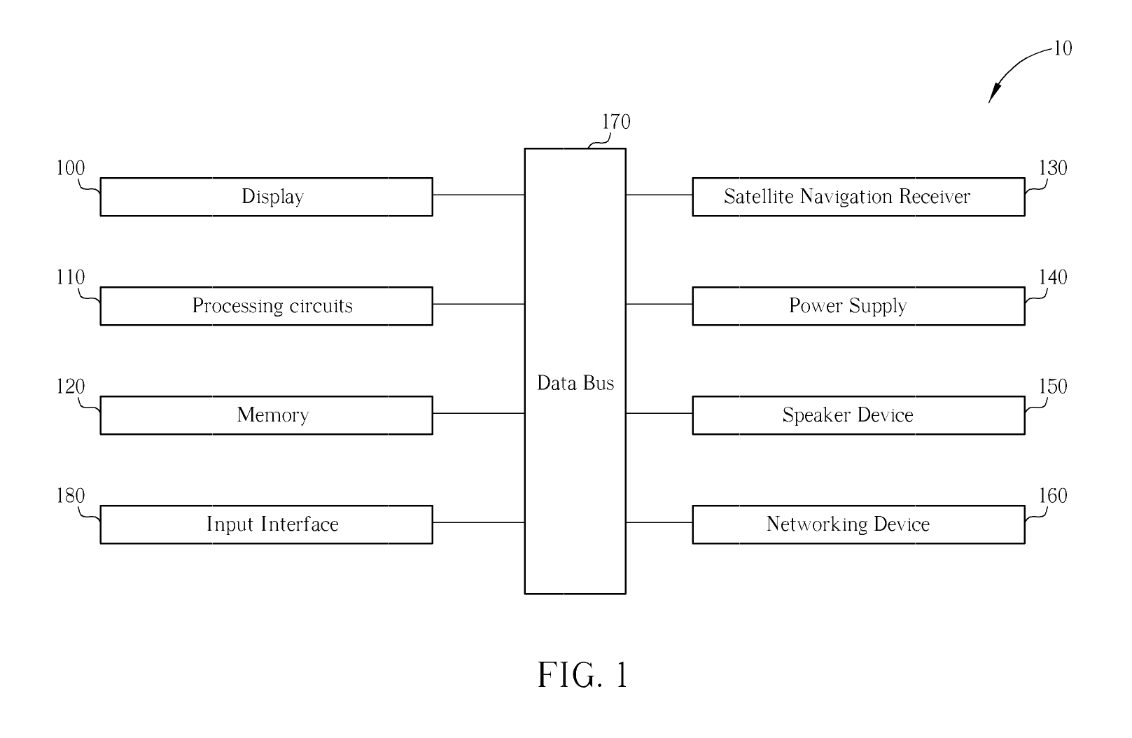

Please refer to FIG. 1, which is a diagram of a personal navigation device 10 according to an embodiment of the present invention. The personal navigation device 10 may be a handheld device, and may comprise components such as a display 100, processing circuits 110, memory 120, a satellite navigation receiver 130, a power supply 140, a speaker device 150, and a networking device 160. The personal navigation device 10 may be configured to be powered through a battery unit, or through an external power source, such as a car adapter. The personal navigation device 10 may comprise an input interface 180, such as a keypad, for receiving user input. The input interface 180 may be a touch-sensitive layer applied to the display 100, e.g. a resistive or capacitive touch screen. The processing circuits 110 may include logic circuits, controller circuits, and internal memory. The memory 120 may include a nonvolatile memory chip and external memory, such as a memory card. The networking device 160 may be a wireless or wired network interface device, such as a general packet radio service (GPRS) modem, and may establish a network connection with the server. The satellite navigation receiver 130, which may be considered positioning circuits, may receive satellite navigation signals, such as Global Positioning System signals, and may determine position of the personal navigation device 10 based on the satellite navigation signals. The components may be connected through a data bus 170 for transmitting and receiving commands and data between the various components.

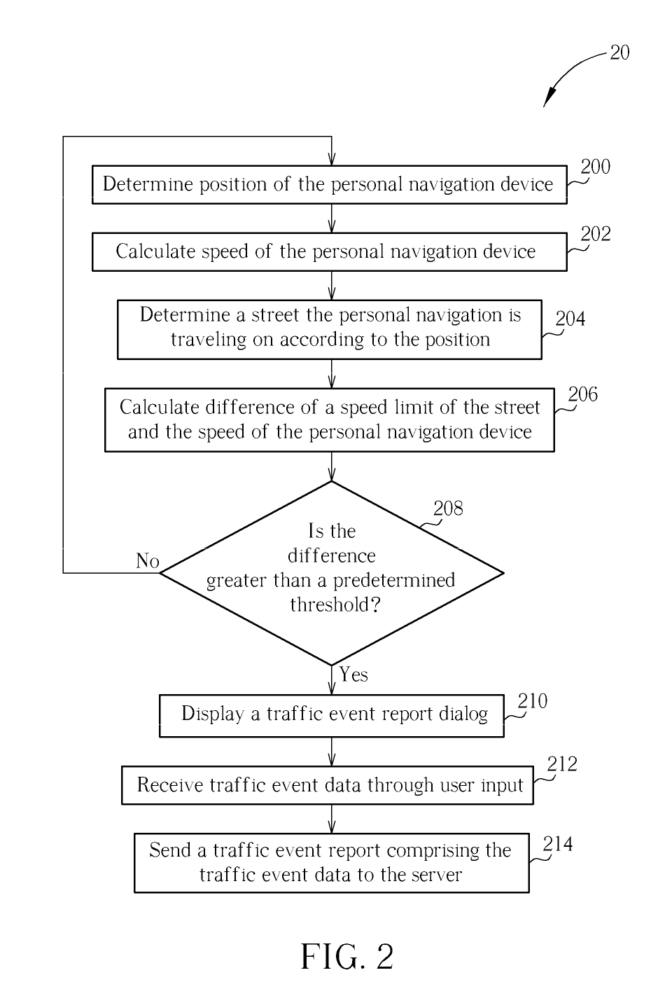

Please refer to FIG. 2, which is a flowchart of a process 20 for a personal navigation device, such as the personal navigation device 10, transmitting a traffic event report corresponding to the traffic event to the server according to a first embodiment of the present invention. The process 10 comprises the following steps:

Step 200: Determine position of the personal navigation device.

Step 202: Calculate speed of the personal navigation device.

Step 204: Determine a street the personal navigation is traveling on according to the position.

Step 206: Calculate difference of a speed limit of the street and the speed of the personal navigation device.

Step 208: If the difference is greater than a predetermined threshold, go to Step 210. Else, go to Step 200.

Step 210: Display a traffic event report dialog.

Step 212: Receive traffic event data through user input.

Step 214: Send a traffic event report comprising the traffic event data to the server.

In the process 20, the personal navigation device 10 may automatically display the traffic event report dialog (Step 210) in the display 100 under certain conditions corresponding to occurrence of the traffic event. The traffic event report dialog may be a graphical form displayed in the display 100, and may comprise a plurality of fields, radio buttons, combo boxes, drop-down lists, check boxes, and/or other such graphical user interface control elements. The speed may be calculated by the processing circuit 110 according to the position determined. If the speed of the personal navigation device 10 is lower than a speed limit of the street the personal navigation device 10 is traveling on by a predetermined threshold (Step 208), which may be stored in the memory 120, the personal navigation device 10 may display the traffic event report dialog in the display 100. In Step 210, the personal navigation device 10 may suggest traffic event candidates in the display 100 for the user to choose from based on the conditions detected, e.g. congestion, an accident, a road closure, a lane closure, etc. The personal navigation device 10 may automatically determine data, such as time of day, position, heading, street, street address, and fill in the data automatically when displaying the traffic event report dialog (Step 210). Other data, such as an identifier of the personal navigation device, a username of the user, and/or other information relevant to reporting the traffic event may be stored in the memory 120, and may also be filled in automatically. The data and the traffic event data received through the user input (Step 212) may be included in the traffic event report. Then, the personal navigation device may send the traffic event report to the server (Step 214) through the networking device 160 when the user issues a command to submit the traffic event report through the input interface 180. Other drivers who pass through the same area may choose to download the latest information from other users, such as the user. In another embodiment, the user may generate a traffic event report in the personal navigation device 10 manually using the input interface 180, and the personal navigation device 10 may transmit the traffic event report to the server through the networking device 160. The traffic event report may comprise position of the personal navigation device 10, heading of the personal navigation device 10, speed of the personal navigation device 10, time of day (a timestamp), type of traffic event, an identifier of the personal navigation device 10, a username of the user, and/or other information relevant to reporting the traffic event. The user may perform a sequence of keystrokes in the input interface 180 to open a traffic event report interface, such as the traffic event report dialog, enter part or all of the above information in the traffic event report interface through text input, checkbox selection, radio button selection, and/or combo box selection, and control the networking device 160 of the personal navigation device to transmit the traffic event report to the server through further button presses or keystrokes. Any combination of automatic and manual entry of the above information may be made. The information automatically generated by the personal navigation device 10 may also be manually overwritten by user input through the input interface 180.

In the above, the driver or another passenger may generate the user-generated notification by selecting one or more of the traffic events mentioned above in a user interface displayed in the display 100 of the personal navigation device 10. The user may further utilize the microphone for issuing voice commands for navigating menus of the user interface and entering text. A graphical user interface (GUI) may be displayed in a display of the personal navigation device for showing input text fields, combo boxes, radio buttons, etc. for allowing the user to input the abovementioned information about the traffic event either through key strokes and/or voice commands. For example, the navigation device may have an application related to reporting traffic events, and the driver may press a button, or utter a voice command, to select the traffic event type. Once the traffic event type is selected, the navigation device may transmit the traffic event type to the server, along with the position, the heading, and other information of the personal navigation device.

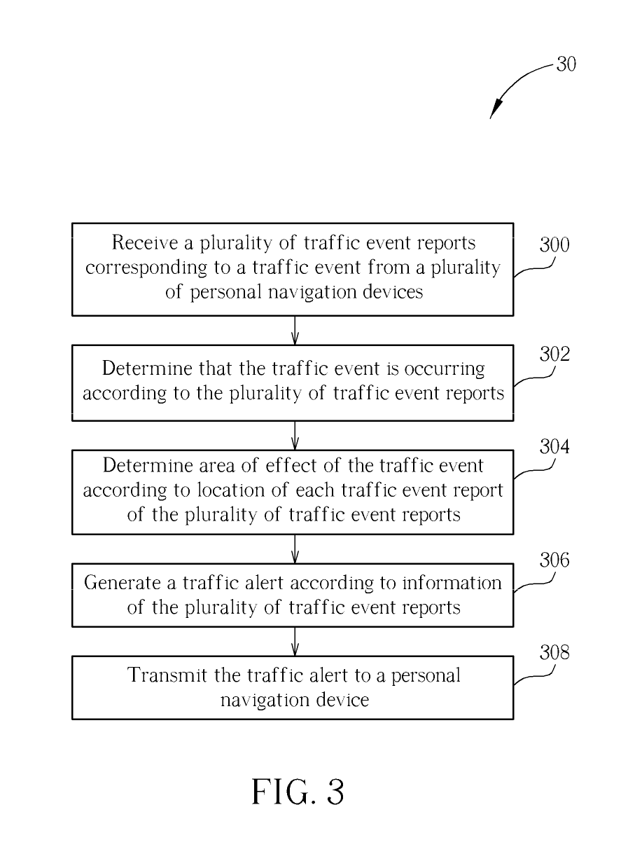

Please refer to FIG. 3, which is a flowchart of a process 20 for a server transmitting a traffic event report corresponding to the traffic event to a personal navigation device according to an embodiment of the present invention. The process 30 comprises the following steps:

Step 300: Receive a plurality of traffic event reports corresponding to a traffic event from a plurality of personal navigation devices.

Step 302: Determine that the traffic event is occurring according to the plurality of traffic event reports.

Step 304: Determine area of effect of the traffic event according to location of each traffic event report of the plurality of traffic event reports.

Step 306: Generate a traffic alert according to information of the plurality of traffic event reports.

Step 308: Transmit the traffic alert to a personal navigation device.

From the perspective of the server, the server may receive a plurality of traffic event reports (Step 300). The traffic event reports may be user-generated notifications and/or navigation-device-generated notifications, and may be sent from a plurality of personal navigation devices. For example, five different users utilizing five respective personal navigation devices may all send notifications to the server regarding the traffic event, which may be a collision, road construction, heavy traffic, etc. Each notification may also include various types of information, such as position, bearing, time, street name, street address, etc. Over a predetermined period of time, e.g. 5 minutes, 10 minutes, 30 minutes, etc., the server may receive a significant volume of notifications from the personal navigation devices. The significant volume may be as low as one notification, with no upper limit. Utilizing the plurality of notifications, the server may then determine that the traffic event is occurring (Step 302), and may also determine an area of effect of the traffic event (Step 304), e.g. heavy traffic northbound on an interstate highway for 1 mile. Information received through the plurality of traffic event reports may be converted into a traffic alert (Step 306) by the server. The plurality of traffic event reports may correspond to the area, but may have different information. The server may select the type of the traffic event from the traffic event reports based on position and/or specificity. For example, one user may submit a first traffic event report comprising congestion at a first location at a first time, and another user may submit a second traffic event report comprising a car accident at a second location at a second time. If the second location is further down the street than the first location, and the headings indicated in the first and second traffic event reports are the same, the second user may have more specific information about the traffic event than the first user. Whereas the first user may only see congestion, the second user may already know the cause of the congestion, e.g. road construction, a car accident, a road closure, etc. Thus, the server may choose “car accident” as the type of the traffic event based on the second location being further down the street than the first location. Or, the server may choose “car accident” based on “car accident” being more specific than “congestion”. Once the traffic alert has been generated, the server may transmit the traffic alert to personal navigation devices (Step 308). The traffic event report may be transmitted in a number of different ways, including a broadcast, through a network connection, through a short message service (SMS) message, or through another radio, text, or data format. The traffic event report may also be made available for download, and sent to a requesting personal navigation device when the server receives a request from the requesting personal navigation device. The information about the traffic event may be sent according to a geographic region. For example, the information about the traffic event may be sent to personal navigation devices located within a predetermined distance of position of the traffic event, and/or to personal navigation devices located within a predetermined time period of the traffic event. The server may delete the notification according to a predetermined expiration period, such as 5 minutes, 15 minutes, 30 minutes, etc.

When the personal navigation device receives the information about the traffic event, the personal navigation device may then display a representation of the traffic event on a map of the navigation device. The personal navigation device may route away from, or around, the traffic event. The personal navigation device may display the traffic event in a list. The personal navigation device may also give verbal notification of the traffic event to the driver.

Over time, as the traffic event is resolved, the server may receive fewer notifications related to the traffic event, and as older notifications expire and are deleted, the server may delete the traffic event, and no longer transmit the traffic event report to the navigation devices. The server may also receive user-generated notifications indicating that the traffic event is no longer valid, or that traffic is smooth where the traffic event was originally located. At this point, the server may also delete the traffic event and no longer transmit the traffic event to the navigation devices.

Regarding navigation-device-generated notifications, the server may receive the navigation-device-generated notifications from the personal navigation devices. In contrast to the user selecting the traffic event from a list, or inputting the traffic event manually through other means, the personal navigation device may also automatically determine the traffic event based on information collected by the personal navigation device, such as the position, bearing, speed, etc. of the personal navigation device. For example, the navigation device may utilize the position and bearing of the navigation device to determine a street that the navigation device is located on, and which direction the navigation device is traveling in. As most map databases not only include street names, but also typical speeds relative to each street in the map database, the navigation device may easily determine that the speed of the navigation device is slower than the typical speed of the street the navigation device is on. In this case, if the speed of the personal navigation device is slower than the typical speed by a predetermined amount, the personal navigation device may generate the navigation-device-generated notification and send it to the server. If the navigation device is stopped, the navigation device may also generate the navigation-device-generated notification to the server. The personal navigation device may also request that the driver or another passenger identify the traffic event when the navigation device generates the notification based on the information collected by the navigation device. So, although the personal navigation may not be able to distinguish between heavy traffic and a road closure, both options may be presented for selection, and the notification sent to the server may include the traffic event selected by the user.

Compared to the prior art, which does not provide a method for notifying users of personal navigation devices of traffic events based on inputs from other personal navigation devices, a method of transmitting traffic events to the personal navigation devices that can be user-originated, device-originated, or a hybrid of both is provided. The methods described allow for rapid and accurate detection and dissemination of traffic events.

Those skilled in the art will readily observe that numerous modifications and alterations of the device and method may be made while retaining the teachings of the invention.

What is claimed is:

1. A method of transmitting a traffic event report for a traffic event from a personal navigation device comprising processing circuits, positioning circuits, memory circuits, an input interface, a display, and networking circuits, the method comprising:
the positioning circuits determining a position of the personal navigation device;
the processing circuits calculating a speed of the personal navigation device according to the position;
the processing circuits determining a street the personal navigation device is traveling on according to the position;
the processing circuits calculating a difference of a speed limit of the street and the speed of the personal navigation device;
the processing circuits displaying a traffic event report dialog in the display upon detection of the difference being greater than a predetermined threshold;
the input interface receiving traffic event data through user input into the traffic event report dialog; and
the networking circuits sending the traffic event report comprising the traffic event data to the server.

2. The method of claim 1, wherein the input interface receiving the traffic event data through the user input is the input interface receiving type of the traffic event through the user input.

3. The method of claim 1, wherein the networking circuits sending the traffic event report comprising the traffic event data to the server is the networking circuits sending the traffic event report comprising the traffic event data, the position, and a timestamp to the server.

4. The method of claim 1, further comprising:
the processing circuits determining a heading of the personal navigation device;
wherein the networking circuits sending the traffic event report comprising the traffic event data to the server is the networking circuits sending the traffic event report comprising the traffic event data and the heading to the server.

5. The method of claim 1, wherein the networking circuits sending the traffic event report comprising the traffic event data to the server is the networking circuits sending the traffic event report comprising the traffic event data and the street to the server.

6. The method of claim 1, wherein the processing circuits displaying the traffic event report dialog in the display upon detection of the difference being greater than the predetermined threshold is the processing circuits displaying the traffic event report dialog in the display upon detection of the speed of the personal navigation device being slower than the speed limit by more than the predetermined threshold.

7. The method of claim 1, wherein the processing circuits displaying the traffic event report dialog in the display upon detection of the difference being greater than the predetermined threshold is the processing circuits displaying a graphical form comprising a plurality of control elements corresponding to a plurality of traffic event types.

8. The method of claim 7, wherein the plurality of traffic event types comprises an accident type, a road closure type, a lane closure type, a construction type, and/or a heavy traffic type.

9. The method of claim 1, further comprising:
the input interface receiving login information corresponding to a user account on the server.

10. The method of claim 9, wherein the networking circuits sending the traffic event report comprising the traffic event data to the server is the networking circuits sending the traffic event report comprising the traffic event data and username of the user account to the server.

11. A personal navigation device for transmitting a traffic event report to a server, the personal navigation device comprising:
a display;
positioning circuits configured for determining position of the personal navigation device;
networking circuits configured for establishing a network connection with the server for transmitting the traffic event report to the server;
an input interface configured for receiving traffic event data through user input; and
processing circuits configured for calculating speed of the personal navigation device according to the position, determining a street the personal navigation device is traveling on according to the position, calculating difference of a speed limit of the street and the speed of the personal navigation device, displaying a traffic event report dialog in the display upon detection of the difference being greater than a predetermined threshold, and controlling the networking circuits to transmit the traffic event report comprising the traffic event data to the server.

12. The method of claim 11, wherein the input interface is configured for receiving type of the traffic event through the user input.

13. The method of claim 11, wherein the processing circuits are configured for controlling the networking circuits to send the traffic event report comprising the traffic event data and the position to the server.

14. The method of claim 11, wherein the processing circuits are configured for controlling the networking circuits to send the traffic event report comprising the traffic event data and a timestamp to the server.

15. The method of claim 11, wherein the processing circuits are configured for determine a heading of the personal navigation device, and for controlling the networking circuits to send the traffic event report comprising the traffic event data and the heading to the server.

16. The method of claim 11, wherein the processing circuits are configured for controlling the networking circuits to send the traffic event report comprising the traffic event data and the street to the server.

17. The method of claim 11, wherein the traffic event report dialog is a graphical form comprising a plurality of control elements corresponding to a plurality of traffic event types.

18. The method of claim 17, wherein the plurality of traffic event types comprises an accident type, a road closure type, a lane closure type, a construction type, and/or a heavy traffic type.

19. The method of claim 11, wherein the input interface is configured for receiving login information corresponding to a user account on the server.

20. The method of claim 19, wherein the processing circuits are configured for controlling the networking circuits to send the traffic event report comprising the traffic event data and username of the user account to the server.
